(19) United States
(12) Patent Application Publication
(10) Pub. No.: US 2015/0336462 A1
(43) Pub. Date: Nov. 26, 2015

(54) SONIC TRIANGULATION METHOD FOR LOCATING VEHICLES FOR HANDS-FREE ELECTRIC VEHICLE CHARGING

(71) Applicant: FORD GLOBAL TECHNOLOGIES, LLC, Dearborn, MI (US)

(72) Inventor: Christopher W. BELL, Livonia, MI (US)

(73) Assignee: FORD GLOBAL TECHNOLOGIES, LLC, Dearborn, MI (US)

(21) Appl. No.: 14/283,281

(22) Filed: May 21, 2014

(51) Int. Cl. B60L 11/18

(52) U.S. Cl. CPC B60L 11/182

(57) ABSTRACT

A charging system for charging a vehicle includes a charging station and a vehicle. The charging station includes a wireless charging coil, a sonic receiver oriented to receive sonic signals generated proximate the coil, and a first wireless communications device. The vehicle includes a charge plate, a first emitter configured to generate a first sonic signal, a second wireless communications device in communication with the first wireless communication device, an in-vehicle display, and at least one controller. The controller is configured to present positional information via the display. The positional information corresponds to a vehicle position detected in response to the first sonic signal being received by the sonic receiver.

### TECHNICAL FIELD

This disclosure relates to charging stations and the recharging of batteries in electric and hybrid electric vehicles.

### BACKGROUND

Charging methods for battery electric vehicles (BEVs) and plug-in hybrid electric vehicles (PHEVs) have increased in prevalence as advancements in vehicle propulsion and battery technology have occurred. Some charging methods include wireless charging, such as inductive charging. Inductive charging systems include a primary charging coil that is energized with an electric current. The primary charging coil induces a current in a secondary charging coil, which may be used to charge a battery.

### SUMMARY

A plug-in vehicle according to the present disclosure includes a first emitter configured to generate a first sonic signal, a vehicle wireless communications device configured to communicate with a charging station wireless communication device, an in-vehicle display, and at least one controller. The controller is configured to present positional information via the display. The positional information corresponds to a vehicle position detected in response to the first sonic signal being received by a charging station sonic receiver.

In some embodiments, the vehicle further comprises a second emitter configured to generate a second sonic signal. In such an embodiment, the positional information corresponds to a vehicle position detected in response to the first sonic signal and second sonic signal being received by the sonic receiver. In one such embodiment, the positional information corresponds to a triangulated vehicle position based on a first time delay and a second time delay. The first time delay corresponds to a period between the first signal being produced and the first signal being received by the sonic receiver, and the second time delay corresponds to a time period between the second signal being produced and the second signal being received by the sonic receiver. In some embodiments, the at least one controller is further configured to coordinate an automatic vehicle parking event in response to the positional information. In one embodiment, the vehicle further includes a secondary charging coil In such an embodiment, the positional information includes a distance and lateral offset of the secondary inductive charging coil relative to a primary charging coil.

A wireless charging station according to the present disclosure includes a wireless charging coil, a housing proximate the coil, a sonic receiver retained within the housing, a wireless communications device, and a controller. The controller is in communication with the receiver. The controller is additionally configured to transmit vehicle positional information via the wireless communications device to an associated vehicle wireless communications device. The vehicle positional information is based on at least one signal from first and second associated emitters on a vehicle.

In some embodiments, the at least one sonic signal includes a first signal produced by the first emitter and a second signal produced by the second emitter. In such embodiments, the controller is further configured to triangulate the vehicle positional information in response to the first and second signals.

A plug-in vehicle according to the present disclosure includes a secondary wireless charging coil, a wireless communications device, first and second sonic emitters, an in-vehicle display, and a controller. The controller is configured to present positional information via the display. The positional information is received via the wireless communications device from an associated wireless charging station including a sonic receiver.

In one embodiment, the controller is further configured to coordinate an automatic vehicle parking event in response to the positional information. In an additional embodiment, the controller is further configured to command the first sonic emitter to produce a first signal and the second sonic emitter to produce a second sonic signal. In such an embodiment, the positional information corresponds to a triangulated vehicle position based on the first and second signals being received by the sonic receiver. In some such embodiments, the controller is further configured to triangulate the vehicle position based on a first time delay between the first signal being produced and the first signal being received by the sonic receiver and a second time delay between the second signal being produced and the second signal being received by the sonic receiver.

Embodiments according to the present disclosure provide a number of advantages. For example, the present invention provides a system for wirelessly charging a vehicle that enables precise vehicle parking relative to a charging station. Furthermore, charging stations according to the present disclosure may provide positioning information without direct line of sight to a vehicle.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic representation of a wireless charging system according to the present disclosure including a charging station and a plug-in vehicle;

FIG. 2 illustrates a method determining a position and horizontal offset of a vehicle according to the present disclosure; and

FIG. 3 illustrates a method for controlling a vehicle charging system according to the present disclosure in flowchart form.

### DETAILED DESCRIPTION

As those of ordinary skill in the art will understand, various features of the present invention as illustrated and described with reference to any one of the Figures may be combined with features illustrated in one or more other Figures to produce embodiments of the present disclosure that are not explicitly illustrated or described. The combinations of features illustrated provide representative embodiments for typical applications. However, various combinations and modifications of the features consistent with the teachings of the present disclosure may be desired for particular applications or implementations.

Vehicles may be powered by battery electricity (BEVs) as well as by a combination of power sources including battery electricity. For example, hybrid electric vehicles (HEVs) are contemplated in which the powertrain is powered by both a battery and an internal combustion engine. In these configurations, the battery is rechargeable and a vehicle charger provides power to restore the battery after discharge.

Some vehicles and associated charging stations are equipped for hands-free wireless charging. To charge vehicles using such a system, the vehicle must be precisely located relative to the charger. A secondary charging coil in the vehicle must be positioned within a certain distance and orientation of a primary charging coil in order to effectively charge a vehicle battery.

One possible solution includes providing sensors on the vehicle that are equipped to detect a charging station location. However, such implementations must be sufficiently robust to function in the presence of displaced road debris including tire-propelled mud, ice, or dirt. Robust sensors capable of withstanding such road hazards may be expensive.

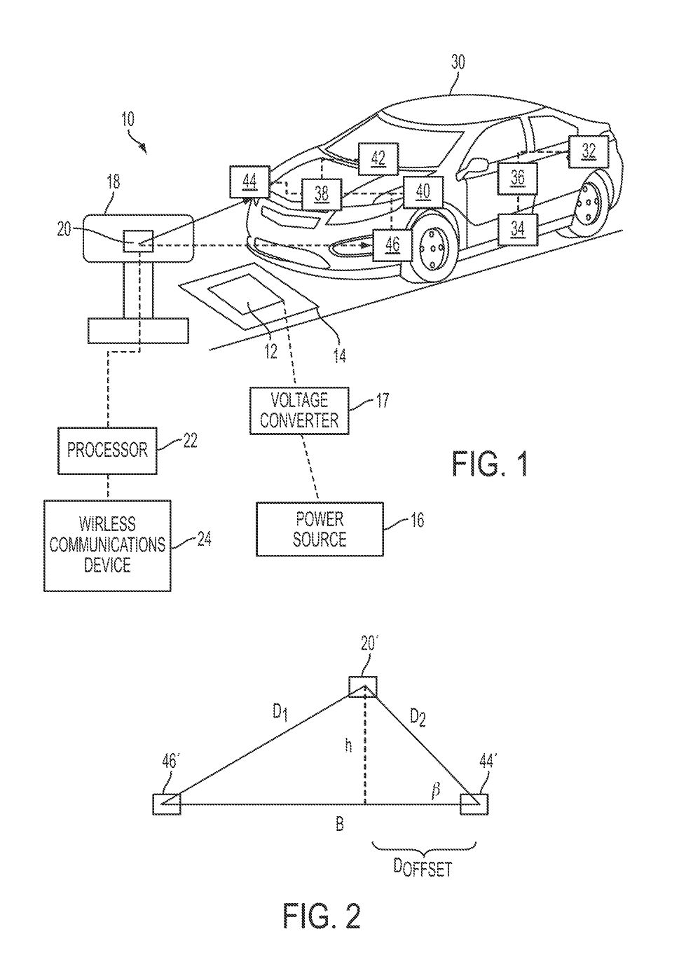

Referring now to FIG. 1, a charging system for a plug-in vehicle according to the present disclosure is illustrated in schematic form. The charging system includes a charging station 10. The charging station 10 is configured for inductive charging and includes a primary charging coil 12 housed within a primary induction charging plate 14. The primary charging coil 12 is electrically connected to an electric power source 16 via a power converter 17. The power converter 17 converts current from the power source 16 to a different voltage and/or frequency and provides current to the primary charging coil 12. The primary charging coil 12 generates an electromagnetic field about the primary induction charging plate 14. When a corresponding secondary coil is placed in proximity to the powered primary induction charging plate 14, it receives power by being within the generated electromagnetic field. The primary induction charging plate 14 may, in some embodiments, be provided with an articulated arrangement to raise and lower the primary charging coil relative to a vehicle for charging.

The wireless charging station additionally includes a housing 18. The housing is positioned proximate the primary induction charging plate 14. The housing 18 preferably includes a driver targeting aid to provide visual guidance to a driver. The driver targeting aid may include an arrow, a bull's-eye, crosshairs, or any other appropriate indicator of where to aim a vehicle for proper location relative to the primary induction charging plate 14. The wireless charging station further includes a sensor 20. The sensor 20 is associated with the housing and generally oriented toward the primary induction charging plate 14. The sensor 20 is oriented to receive signals emitted in the vicinity of the primary induction charging plate 14. In a preferred embodiment, the sensor 20 is an acoustic receiver. In some embodiments other types of sensors may be used, or a combination of acoustic and other sensors may be used. Additional sensors may, of course, also be used.

The sensor 20 is in communication with a processor 22. The processor 22 may configured to calculate a position of a vehicle, including distance and horizontal offset, in response to signals from the sensor 20, as will be discussed below. The processor 22 is additionally in communication with a wireless communications device 24. The processor 22 is configured to transmit positional information of a vehicle to the vehicle via the wireless communications device 24. The processor 22 and wireless communications device 24 may be retained within the housing 18, primary induction charging plate 14, or other appropriate location. Communications cables may run between the housing 18 and components retained within the primary induction charging plate 14.

The charging system additionally includes a vehicle 30. The vehicle 30 is a battery electric vehicle (BEV) or plug-in hybrid electric vehicle (PHEV). The vehicle 30 includes a battery 32 and a secondary induction coil 34. The secondary induction coil 34 generates current in response to an electromagnetic field generated by the primary induction coil 12. The vehicle 30 additionally includes an AC-to-DC converter 36. The converter 36 converts AC current generated by the secondary induction coil 34 to DC current to recharge the battery 32.

The vehicle 30 additionally includes at least one controller 38. Although it is shown as a single controller, the vehicle controller 38 can include multiple controllers that are used to control multiple vehicle systems. For example, the vehicle controller 38 can be a vehicle system controller/powertrain control module (VSC/PCM). In this regard, the vehicle charging control portion of the VSC/PCM can be software embedded within the VSC/PCM, or it can be implemented in a separate hardware device. The vehicle controller 38 generally includes any number of microprocessors, ASICs, ICs, memory (e.g., FLASH, ROM, RAM, EPROM and/or EEPROM) and software code to co-act with one another to perform a series of operations. The vehicle controller 68 additionally communicates with other controllers and components over a hardline vehicle connection using a common bus protocol (e.g. CAN).

The controller 38 is in electric communication with a vehicle wireless communications device 40. The vehicle wireless communications device 40 is in wireless communication with the charging station wireless communications device 24. In a preferred embodiment, the charging station wireless communications device 24 and vehicle wireless communications device 40 are both WiFi devices. Other wireless communications methods may of course be used, such as Bluetooth. The controller 38 is configured to receive positional information via the vehicle wireless communications device 40. The wireless communication between the vehicle wireless device 40 and charging station wireless communications device 24 may be used to transmit other information, as well. For example, the wireless communication may be used to complete an association procedure between the vehicle 30 and the charging station 10, in response to which vehicle charging may be initiated.

The controller 38 is additionally in communication with a driver display 42. The driver display may be a dashboard multifunction display or other displays as appropriate. The controller is configured to provide the positional information to a driver via the driver display 42. The driver display may include any appropriate representation of the vehicle positional information to illustrate the vehicle position and orientation, including distance and horizontal offset relative to the primary induction charging plate 14. In response to this information, the driver may more accurately park the vehicle with the secondary induction coil 34 proximate the primary induction charging plate 14.

The vehicle additionally includes a first sonic emitter 44 and a second sonic emitter 46. The sonic emitters 44 and 46 are in communication with the controller 38. The sonic emitters 44 and 46 are placed at specified locations near the front of the vehicle. In the embodiment illustrated, the first sonic emitter 44 is located on a passenger side of the vehicle and the second sonic emitter 46 is located on a driver side of the vehicle. The sonic emitters 44 and 46 are configured to emit bursts of sound at frequencies above those audible to humans. In a preferred embodiment, the first sonic emitter 44 and the second sonic emitter 46 are electrically connected on a same circuit. In this fashion, a command to generate an acoustic signal will trigger a simultaneous signal from both the first sonic emitter 44 and the second sonic emitter 46.

In some embodiments, the vehicle 30 is equipped with an auto park system. In such embodiments, a controller, which may be controller 38 or other appropriate controllers, issues commands to various vehicle systems to coordinate an automatic parking event. During an automatic parking event, vehicle steering, acceleration, and braking systems (not illustrated) are automatically controlled to park the car in an appropriate parking location and orientation. The controller will use the positional information from the charging station 10 to coordinate the various systems and park the vehicle with the secondary induction coil 34 proximate the primary induction charging plate 14 for charging.

Variations of the above system are, of course, possible. For example, the sensor 20 may be operatively coupled to the primary induction charging plate 14, rather than the housing 18 as illustrated in FIG. 1. In another variation, the sensor 20 is operatively coupled to the voltage converter 17. The above and other sensor locations may all be used in conjunction with methods according to the present disclosure. In some embodiments, the vehicle is equipped with an automatic parking system, and the positional information is used by an Auto Park system to facilitate hands-free parking.

Referring now to FIG. 2, a method for determining a distance and horizontal offset of a vehicle according to the present disclosure is illustrated. A receiver 20′ is mounted near a desired parking spot. First and second emitters 44′ and 46′ are coupled to a front portion of a vehicle, spaced apart by a known distance B. The emitters 44′ and 46′ are configured to generate first and second sound bursts, respectively, at substantially the same time. The receiver 20′ receives the respective sound bursts generated by emitters 44′ and 46′ and timestamps the arrival of the sound bursts.

The system may calculate first and second time delays corresponding with the time elapsed between the generation of the sound bursts and the reception of the first and second sound bursts, respectively. Based on the speed of sound in air, the system may then calculate a first distance D₁ from the receiver 20′ to the first emitter 44′ and a second distance D₂ from the receiver 20′ to the second emitter 46′. With that information, along with the known distance B between the sound emitters 44′ and 46′, the charge system may generate a geometric triangle, the angles and sides of which represent positional information of the vehicle, including the distance of the vehicle from the receiver 20′ and how far offset the centerline of the vehicle is from the position of the receiver 20′. Performing geometric and trigonometric computations based on the received data, the vehicle location can be determined with a high degree of accuracy.

Heron's formula may be used to find the distance between the receiver 20′ and the vehicle.

$$S = \frac{B + {D}_{1} + {D}_{2}}{2}$$

$$A = \sqrt{S ( S - B ) ( S - {D}_{1} ) ( S - {D}_{2} )}$$

where A equals the area of the triangle defined by B, D₁, and D₂.

Substituting the above calculated area into the formula for the area of a triangle, one obtains

$$h = \frac{2 A}{B}$$

where h is the distance from the receiver 20′ to the vehicle.

Furthermore, the above-calculated figures may be used to determine an offset between the position of the receiver 20′ and the centerline of the vehicle. Using the Law of Cosines and the Pythagorean Theorem,

$$β = {cos}^{- 1} ( \frac{{B}^{2} + {D}_{2}^{2} - {D}_{1}^{2}}{2 {BD}_{2}} )$$

$${D}_{offset} = \frac{h}{tan β}$$

where D_{offset} is the horizontal offset between the receiver 20′ and the centerline of the vehicle.

Advantageously, triangulation based on first and second time delays, as discussed above, does not require line of sight between the first and second emitters and the receiver. Thus the receiver may be placed in a variety of locations regardless of the presence of visual obstructions between the receiver and emitters.

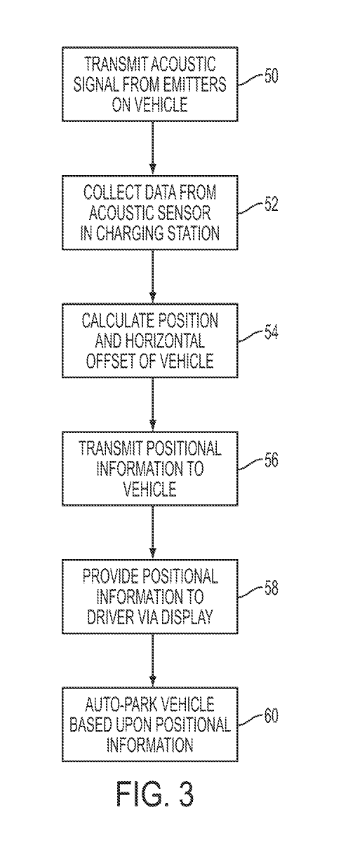

Referring now to FIG. 3, a method for controlling a vehicle charging system according to the present disclosure is illustrated in flowchart form. An acoustic signal is transmitted from emitters on a vehicle, as illustrated at block 50. Data is collected from an acoustic sensor disposed in a charging station, as illustrated at block 52. The distance and horizontal offset to a detected vehicle is calculated, as illustrated at block 54. Positional information is transmitted to the vehicle, as illustrated at block 56. Positional information is provided to the driver via an in-vehicle display, as illustrated at block 58. In vehicles equipped with an auto-park system, the vehicle is automatically parked based upon the positional information received from the charging station, as illustrated at block 60.

In a variation of the above method, a vehicle with an auto-park system may be configured not to display positional information to the driver, as the driver does not need to interact with the vehicle during the parking process.

Additionally, variations may be utilized in other parking situations requiring precise vehicle location. A similar triangulation method may thus be used in vehicles that are not equipped with charging plates, but must be precisely located relative to a target for other purposes.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

As can be seen from the various embodiments, the present invention provides a system for wirelessly charging a vehicle that enables precise vehicle parking relative to a charging station. Furthermore, charging stations according to the present disclosure may provide positioning information without direct line of sight to a vehicle.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A plug-in vehicle comprising:
a first emitter configured to generate a first sonic signal;
a vehicle wireless communications device configured to communicate with a charging station wireless communications device;
an in-vehicle display; and
at least one controller configured to present positional information via the display, the positional information corresponding to a vehicle position detected in response to the first sonic signal being received by a charging station sonic receiver.

2. The plug-in vehicle of claim 1, further comprising a second emitter configured to generate a second sonic signal, wherein the positional information corresponds to a vehicle position detected in response to the first sonic signal and second sonic signal being received by the sonic receiver.

3. The plug-in vehicle of claim 2, wherein the positional information corresponds to a triangulated vehicle position based on a first time delay between the first signal being produced and the first signal being received by the sonic receiver and a second time delay between the second signal being produced and the second signal being received by the sonic receiver.

4. The plug-in vehicle of claim 1, wherein the at least one controller is further configured to coordinate an automatic vehicle parking event in response to the positional information.

5. The plug-in vehicle of claim 1, further comprising a secondary inductive charging coil, wherein the positional information includes a distance and lateral offset of the secondary inductive charging coil relative to a primary inductive charging coil.

6. A wireless charging station for a vehicle comprising:
a sonic receiver proximate a wireless charging coil;
a wireless communications device; and
a controller in communication with the receiver and wireless communications device and configured to transmit vehicle positional information to an associated vehicle wireless communications device, the vehicle positional information being based on at least one signal from at least one associated vehicle emitter received by the receiver.

7. The wireless charging station of claim 6, wherein the at least one associated vehicle emitter includes first and second emitters, the at least one signal includes a first sonic signal produced by the first emitter and a second sonic signal produced by the second emitter, and the controller is further configured to triangulate the vehicle positional information in response to the first and second sonic signals being received by the receiver.

8. The wireless charging station of claim 6, further comprising a housing including a driver targeting aid, the housing being located proximate the coil to provide visual guidance to a driver, wherein the sonic receiver is retained within the housing.

9. The wireless charging station of claim 6, wherein the sonic receiver is operably coupled with the coil.

10. The wireless charging station of claim 6, further comprising a power converter electrically coupled with the coil, wherein the sonic receiver is operably coupled with the power converter.

11. A plug-in vehicle comprising:
a secondary wireless charging coil;
a wireless communications device;
first and second sonic emitters;
an in-vehicle display; and
a controller in communication with the secondary coil, communications device, first and second emitters, and display, the controller being configured to present positional information via the display, the positional information being received via the wireless communications device from an associated wireless charging station including a sonic receiver.

12. The plug-in vehicle of claim 11, wherein the controller is further configured to coordinate an automatic vehicle parking event in response to the positional information.

13. The plug-in vehicle of claim 11, wherein the controller is further configured to command the first sonic emitter to produce a first signal and the second sonic emitter to produce a second sonic signal, and the positional information corresponds to a triangulated vehicle position based on the first and second signals being received by the sonic receiver.

14. The plug-in vehicle of claim 13, wherein the controller is further configured to triangulate the vehicle position based on a first time delay between the first signal being produced and the first signal being received by the sonic receiver and a second time delay between the second signal being produced and the second signal being received by the sonic receiver.
